(19) United States
(12) Patent Application Publication
(10) Pub. No.: US 2008/0023974 A1
(43) Pub. Date: Jan. 31, 2008

(54) JOINT APPARATUS AND HAND APPARATUS FOR ROBOT USING THE SAME

(75) Inventors: Young Jin PARK, Seoul (KR); Yong Sik Park, Pohang-si (KR); Jong Hun Park, Pohang-si (KR); Wan Kyun Chung, Pohang-si (KR)

Correspondence Address: DITTHAVONG MORI & STEINER, P.C., 918 Prince St., Alexandria, VA, 22314, US

(73) Assignee: POHANG INSTITUTE OF INTELLIGENT ROBOTICS, Pohang-si (KR)

(21) Appl. No.: 11/621,849

(22) Filed: Jan. 10, 2007

(30) Foreign Application Priority Data
Jul. 25, 2006 (KR) 2006-0069422

(51) Int. Cl. B25J 15/10

(52) U.S. Cl. 294/106

(57) ABSTRACT

An approach is disclosed for providing a humanoid joint for a robotic system. A joint apparatus includes a supporting part, a rotating part and a pair of joint part, wherein the supporting part and the rotating part are coupled in which the joint part is disposed, wherein a rotational force is initially driven by a joint part and the rotational force is transmitted to the other joint part using a sliding motion generated at an abutted surface of each joint part, wherein the surface is formed at the end of the joint part, wherein the transmitted rotational forces can be converted into a motion by the restriction of movement of joint part occurred within the limited space formed by the coupling of rotational part and supporting part.

### RELATED APPLICATIONS

This application claims the benefit of the earlier filing date under 35 U.S.C. §119 of Korean Patent Application No. 2006-0069422 filed Jul. 25, 2006, entitled “Joint Apparatus and Hand Apparatus for Robot using the same”; the entirety of which is incorporated by reference.

### FIELD OF THE INVENTION

Embodiments of the invention relate to a robot, and more particularly, to provide humanoid joints associated with structure, joint and an actuator for improving performance of a robot capable of human-like sense or touch.

### BACKGROUND OF THE INVENTION

A humanoid robot is a robot with its overall appearance based on that of the human body. In general, humanoid robots have a torso with a head, arms, hands and legs. Some forms of humanoid robots may model only part of the body, for example, face, eyes, mouth and hands.

These humanoid robots resemble a human body and are capable of performing a variety of complex human tasks on commands or by being programmed in advance. However, there exist difficulties in mechanically embodying such function of the human body, especially requiring structuring mechanism in order to embody the mechanism in body motions.

As an example, the humanoid robot hand has a plurality of finger mechanisms (e.g., a thumb, an index finger, a middle finger, a ring finger and a little finger) extended from distal ends of a main body, and each finger mechanism is provided with a plurality of joint portions and a plurality of link members which are respectively disposed between the joint and connected portions in order.

A number of techniques have been developed to propose a robot hands as mimic a functionality of human hand. To achieve this, actuators for driving joint portions of each finger mechanism are provided at a place corresponding to the each finger mechanism. As such, it is required that each of the joint portions is driven by using the actuator directly or through a wire associated with a pulley on which the wires are wound. Some of these traditional approaches for configuring such hand mechanism are fully disclosed in Japanese Patent Laid-Open Publication Nos. sho 60-207795 and Hei 6-8178.

However, these conventional techniques suffer from many drawbacks. For example, in a conventional hand apparatus having a plurality of fingers that require plurality of actuators that are provided at every finger mechanism. As such, even though expanding and contracting action of each finger mechanism can be controlled independently, there exist disadvantages that require separate spaces associated with members for embodying this approach. Consequently, the approach does not permit practical way—it may require complicated structure and significant time to deploy the apparatus.

Furthermore, separate wires for connecting the finger mechanism and actuators corresponding to each movable point can be a burden. For example, spaces through which the wire is passed for electrical connection to actuate the robotic hands that are needed at each joint mechanism for a finger. It is evident that all of these requirements make the structure more complicated.

### SUMMARY OF THE INVENTION

These and other needs are addressed by the invention, in which an approach is presented for accounting for the types of applications as to effectively accommodate for a humanoid joint for a robotic system.

According to one aspect of an embodiment of the invention, a joint apparatus includes a supporting part; and a rotating part configured to be rotated by a rotational force transmitted to the supporting part, wherein the rotating part is coupled to the supporting part; and a joint part configured to convert the rotational force into a rotational motion using a sliding force that is generated at abutted surfaces formed at the end of the joint part in contact, wherein a first joint part resides within the rotating part and a second joint part resides within the supporting part.

According to another aspect of an embodiment of the invention, a hand apparatus for a robot is disclosed. The hand apparatus includes a wrist part; a plurality of finger parts disposed in parallel to the wrist part having a plurality of link members; a joint part disposed between the link members the joint part configured to convert a rotational force generated by a first joint part into a rotational motion of a second joint part, wherein the rotational force is converted into a hand motion occurred at contact surfaces of the each joint part abutted each other; and a thumb part formed at the wrist part configured to be rotated.

According to another aspect of an embodiment of the invention, an apparatus for providing humanoid robot hands is disclosed. A plurality of joint members being coupled within a plurality of structures means for configuring a humanoid robotic hand, wherein the each joint member is a pair and each pair has a symmetrical shape at end; means for disposing the pair within the structure and the each structure is hinged each other, wherein a space is formed at hinged part; and means for providing a rotational force to a joint member, wherein the provided rotational force can be converted to a rotational motion through a sliding force occurred at the contact formed by the symmetrical shape of the each pair abutted against each other, wherein the rotational motion is converted into hand motion by the rotational motion is restricted within the space, wherein a desired motion for the humanoid robot hand can be achieved.

According to yet another aspect of an embodiment of the invention, a method for providing a humanoid joint for a robotic system is provided. The method includes configuring a plurality of elements for embodying the humanoid robotic system, wherein the elements can include a supporting part, a motion part and a joint part; forming a first contact at a hemispherical shape at the end of one joint part; forming a second contact at a hemispherical shape at the end of the other joint, wherein the joint part is a pair; disposing the joint part within the supporting part and the motion part respectively, wherein the supporting part and the motion part are hinged; providing a power to a joint part having the first contact for generating a rotational force, wherein the rotational force is transmitted to the second contact abutted at the first contact at which a sliding force is occurred, wherein the sliding force causes the second contact to move, wherein the movements of the contact are restricted within the space formed at the hinged portion, wherein various motions can be achieved for the humanoid joint.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIG. 1A is a perspective view of a joint apparatus in accordance with an embodiment of the invention;

FIG. 2 is an exploded perspective view of the joint apparatus in accordance with an embodiment of the invention;

FIG. 3 is a cross-sectional view of the joint apparatus in accordance with an embodiment of the invention;

FIG. 4 is a perspective view of a hand apparatus for a robot using the joint apparatus in accordance with an embodiment of the invention;

FIG. 5 is a lower perspective view of the hand apparatus for the robot using the joint apparatus in accordance with an embodiment of the invention;

FIG. 6 is an enlarged perspective view of the hand apparatus for the robot using the joint apparatus in accordance with an embodiment of the invention; and

FIG. 7 is a partially cut-away perspective view showing an internal structure of an index finger part of the hand apparatus for the robot using the joint apparatus in accordance with an embodiment of the invention;

### DETAILED DESCRIPTION

A device, and method for providing humanoid joint for a robotic system are described. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a humanoid robotic hand, it is recognized by one of ordinary skill in the art that the embodiments of the inventions have applicability to any type of robotic system as well any mechanism.

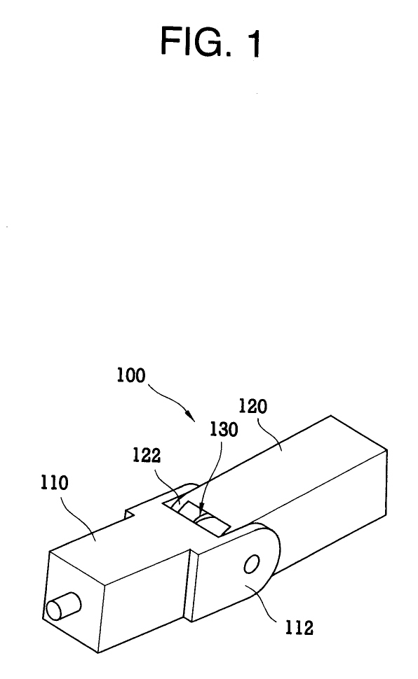

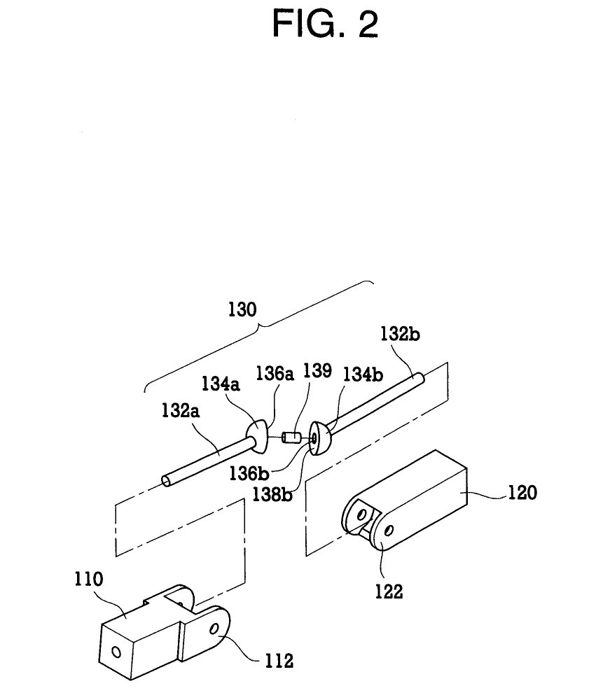

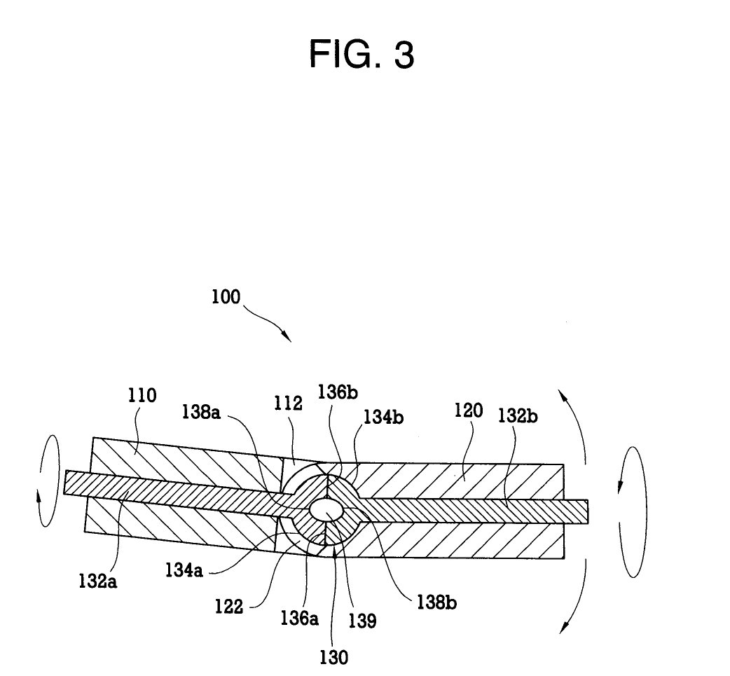

As shown in FIGS. 1 to 3, a joint apparatus 100 of the present invention includes a supporting unit 110 and a rotating unit 120 which are respectively formed into an external frame and rotatably coupled with each other, a joint unit 130 which is provided at an inside of the supporting unit 110 and rotating unit 120 so that the rotating unit 120 is rotated by a sliding frictional motion generated when power is transmitted to the supporting unit 110, and a power unit (not shown) for providing a rotational torque to the joint unit 130.

In this example, the supporting unit 110 and the rotating unit 120 are separated by an operational state. Therefore, the roles of the supporting unit 110 and the rotating unit 120 may be exchanged according to the operational state.

The supporting unit 110 and the rotating unit 120 are formed with an outer coupling part 112 and an inner coupling part 122 at their ends adjacent to each other so that the outer and inner coupling parts 112 and 122 are rotatably coupled with each other, and a space for receiving the joint unit 130 is formed between the outer and inner coupling parts 112 and 122. A rotational center of each of the outer and inner coupling parts 112 and 122 is formed to be the same as that of the joint unit 130.

The joint part 130 is provided with a first joint 132a which is rotatably disposed at an inside of the supporting unit 110 in a length direction of the supporting unit 110, and a second joint 132b which is rotatably disposed at an inside of the rotating unit 120 in a length direction of the rotating unit 120. At each end of the first and second joints 132a and 132b, there are respectively formed with first and second pressure hemispherical parts 134a and 134b.

By way of example, the first and second pressure hemispherical parts 134a and 134b are respectively formed with first and second contact surfaces 136a and 136b which have the same shape and by which the first and second pressure hemispherical parts 134a and 134b are closely contacted with each other. The first and second contact surfaces 136a and 136b are inclined at the same angle, respectively. First and second shaft holes 138a and 138b are respectively formed at center portions of the first and second contact surfaces 136a and 136b so that a rotational shaft 139 is inserted into the first and second shaft holes 138a and 138b so as to be rotated in a state that the first and second contact surfaces 136a and 136b are closely contacted with each other.

The power unit is to provide a rotational force to the first joint 132a which is rotatably disposed in the supporting unit 110. A brushless DC motor (BLDC) is used as the power unit. Also, a reduction gear (not shown) for adjusting a rotational ratio, an encoder (not shown) for detecting a rotational level and the like may be further provided.

As an exemplary embodiment, the operation of the joint apparatus is described in detail. It is noted that each element to be described below shall be understood with reference to FIGS. 1 to 3 and the above descriptions.

In the joint apparatus 110 as described above, the power unit generates power to rotate the rotating part 120 coupled with the supporting part 110. Therefore, the power generated from the power unit is transmitted to the first joint 132a disposed in the supporting unit 110 so as to rotate the first joint 132a. By the rotation of the first joint 132a, the power is transmitted from the first joint 132a to the second joint 132b. As evident from the joint, the second joint 132b is also rotated.

The first joint 132a and the second joint 132b are closely contacted with each other through the first and second contact surfaces 136a and 136b of the first and second pressure hemispherical parts 134a and 134b. The first and second contact surfaces 136a and 136b are contacted and coupled with each other by a rotational shaft 139 in a state of being inclined at a desired angle with respect to a rotational center of the first and second joints 132a and 132b.

Therefore, if the rotational force of the first joint 132a is transmitted to the second joint 132b, a sliding motion is occurred between the first and second contact surfaces 136a and 136b and thus the second joint 132b is rotated with the rotational shaft 139 in the center.

However, since the first and second supporting units 132a and 132b are constrained by the outer and inner coupling parts 112 and 122 of the supporting unit 110 and the rotating unit 120, the rotating unit 120 is rotated with respect to the supporting unit 110 in a state that the rotational motion of the second joint 132b is limited to a direction that the rotating unit 120 can be rotated. Therefore, the rotational force of the power unit can be converted into the rotational motion of the rotating unit 120 with respect to the supporting unit 110.

The hand apparatus for the robot using the joint apparatus according to an embodiment of the invention has a similar shape to a human hand. That is, like the human hand, the hand apparatus is provided with a thumb, an index finger, a middle finger, a ring finger and a little finger. However, if necessary, the number of fingers of the hand apparatus may be changed.

Further, the number of link members and joints forming each finger in the hand apparatus may be the same as that of the human hand. However, if necessary, it may be also changed.

Furthermore, the structure of the link member and joint applies the joint apparatus. Now, a structure and operation of the joint will be described with reference to the drawings.

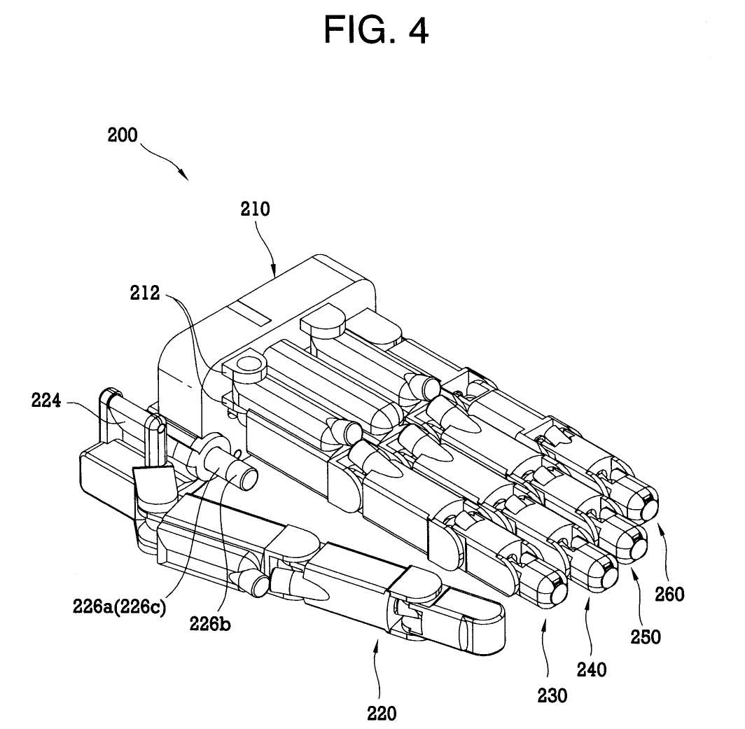

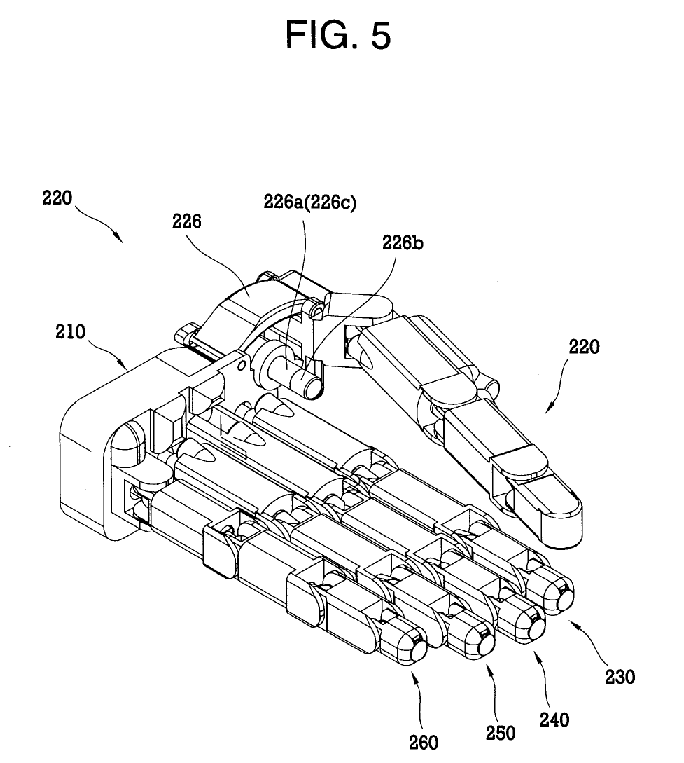

As shown in FIGS. 4 and 5, the hand apparatus 200 using the joint apparatus according to an embodiment of the invention includes a wrist part 210 which is rotatably disposed at an arm part (not shown) of the robot (not shown) and a plurality of finger parts (a thumb part 220, a index finger part 230, a middle finger part 240, a ring finger part 250 and a little finger part 260) extended from the wrist part 210.

The thumb part 220 is rotatably disposed at an outside of the wrist part 210, which is adjacent to a side of the index finger part 230. That is, the thumb part 220 can be rotated to a lower side of the index finger part 230 from the side of the index finger part 230.

The thumb part 220 includes a supporting link 226 for rotatably supporting the thumb part 220 with respect to the wrist part 210, and a rotating link 224 of which one end is rotated by a rotating motor 226a and the other end is coupled with a desired part of the thumb part 220.

If the rotating link 224 is rotated by the rotating motor 226a, the thumb part 220 coupled with the other end of the rotating link 224 is rotated, and the thumb part 220 is rotated to the lower side of the index finger part 230 while being supported by the rotating link 224. The rotating motor 226a may be further provided with an encoder 226b for detecting the rotation of the rotating motor 226a, and a reduction gear 226c for adjusting the rotational ratio of the rotating motor 226a.

The index finger part 230, the middle finger part 240 and the ring finger part 250 are extended from a center portion of the wrist part 210 in one direction with the middle finger part 240 in the center. The index finger part 230 and the ring finger part 250 disposed at both sides of the middle finger part 240 are disposed to be rotated in a horizontal direction with respect to the extended direction of each finger part 230, 240, 250, 260.

Further, each of index finger part 230, the middle finger part 240, the ring finger part 250 and the little finger part 260 is provided with a plurality of link members 232a, 232b, 232c and 232d, and a plurality of joints 234a, 234b, 234c and 234d interposed between adjacent link members. Preferably, each finger part 220, 230, 240, 250 and 260 has a similar structure to the human hand.

In this example, since the index finger part 230, the middle finger part 240, the ring finger part 250 and the little finger part 260 have the same structure and shape except the directions of the link members and the joints which form each finger part, only the index finger part will be described and the description for the other finger part will be omitted.

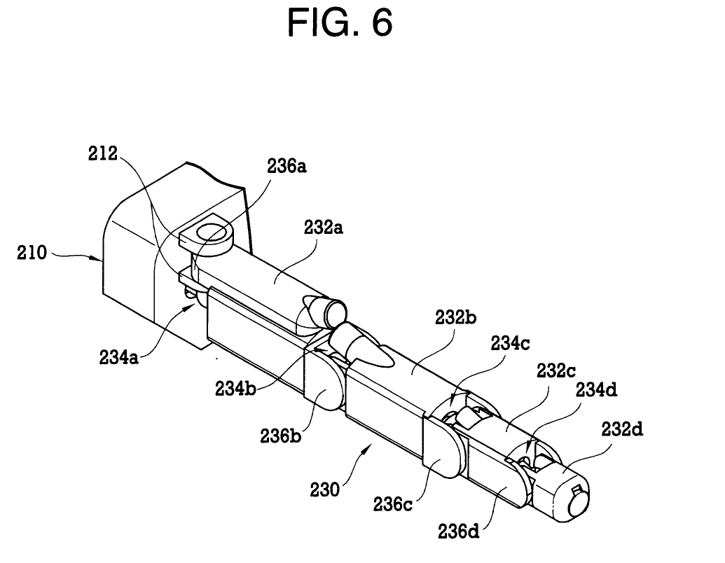

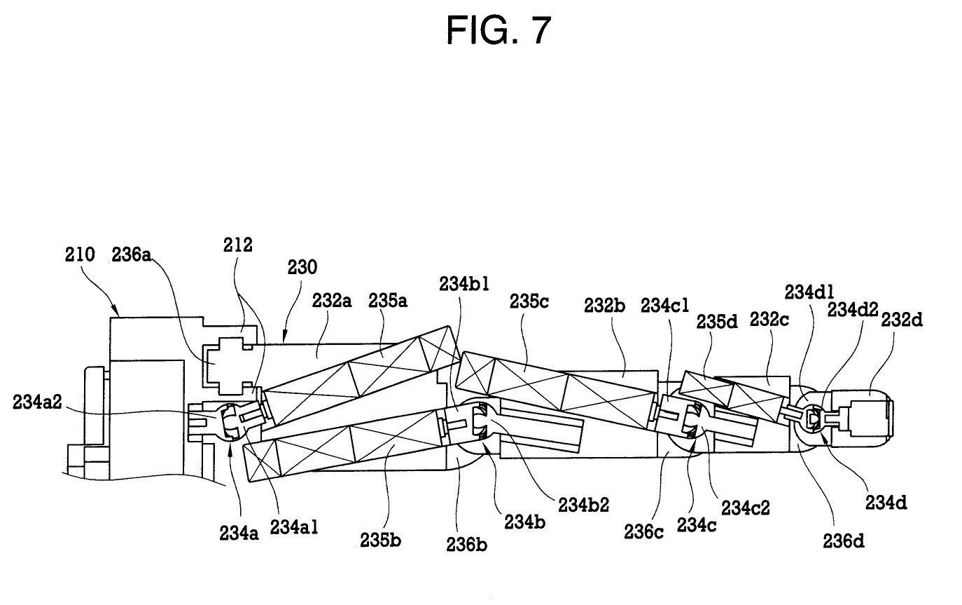

As shown in FIGS. 6 and 7, the index finger part 230 of the hand apparatus 200 for the robot, according to an embodiment of the invention, is coupled with the wrist part 210 so as to be rotated horizontally, and includes a first link member 232a forming a palm portion of the hand apparatus 200, a second link member 232b coupled with the first link member 232a to be rotated vertically, a third link member 232c coupled with the second link member 232b to be rotated vertically, a fourth link member 233d coupled with the third link member 232c to be rotated vertically.

A horizontal hinge part 212 is formed at the wrist part 210 so that the first link member 232a can be rotated horizontally with respect to the palm portion formed by the finger parts. A horizontal rotating part 236a coupled with the horizontal hinge part 212 is formed at an end of the first link member 232a. Further, at a lower side of the horizontal hinge part 212 and the horizontal rotating part 236a, there is provided a first joint part 234a of which one side is coupled with the wrist part 210 and the other side is coupled with the first link member 232a.

A first vertical rotating part 236b is provided between the first link member 232a and the second link member 232b so that the second link member 232b is supported to be rotated vertically with respect to the first link member 232a. A second joint part 234b is provided at an inside of the first vertical rotating part 236b so as to be rotated the second link member 232b with respect to the first link member 232a.

In addition, a second vertical rotating part 236c is provided between the second link member 232b and the third link member 232c so that the third link member 232c is supported to be rotated vertically with respect to the second link member 232b. A third joint part 234c is provided at an inside of the second vertical rotating part 236c so as to be rotated the third link member 232c with respect to the second link member 232b.

Finally, a third vertical rotating part 236d is provided between the third link member 232c and the fourth link member 232d so that the fourth link member 232d is supported to be rotated vertically with respect to the third link member 232c. A forth joint part 234d is provided at an inside of the third vertical rotating part 236d so as to be rotated the fourth link member 232d with respect to the third link member 232c.

As an exemplary embodiment, the first, second and third vertical rotating part 236b, 236c and 236d have respectively the same structure as the outer and inner coupling parts 112 and 122 of the joint apparatus 100 according to an embodiment of the invention.

Meanwhile, the second, third and fourth joint parts 234b, 234c and 234d as described above are mounted in a direction orthogonal to the mounting direction of the first joint part 234a. That is, when the joint parts 234a, 234b, 234c and 234d are respectively operated at their initial positions, the second, third and fourth joint parts 234b, 234c and 234d are operated in a direction orthogonal to an operation direction of the first joint part 234a.

In this example, the first, second, third and fourth joint parts 234a, 234b, 234c and 234d apply the joint apparatus 100 (referring to FIG. 1) according to an embodiment of the invention. The joint parts 234a, 234b, 234c and 234d are respectively provided with first joints 234a1, 234b1, 234c1 and 234d1 and second joints 234a2, 234b2, 234c2 and 234d2. Each of the first joints 234a1, 234b1, 234c1 and 234d1 has a separate power unit 235a, 235b, 235c and 235d.

At each end of the first joints 234a1, 234b1, 234c1 and 234d1 and second joints 234a2, 234b2, 234c2 and 234d2 which are adjacent to each other, there is formed a pressure hemispherical part having an inclined contact surface at a desired angle. The contact surface formed at the pressure hemispherical part is restricted to be rotated around a rotational axis orthogonal to the contact surface. When the rotational force is generated at the first joints 234a1, 234b1, 234c1 and 234d1, the rotational force is transmitted from the first joints 234a1, 234b1, 234c1 and 234d1 to the second joints 234a2, 234b2, 234c2 by the sliding motion between the contact surfaces so that the second joints 234a2, 234b2, 234c2 are rotated. The first joints 234a1, 234b1, 234c1 and 234d1 and the second joints 234a2, 234b2, 234c2 and 234d2 shall be understood with reference to the description of the first joint 132a and the second joint 132b of the joint apparatus.

By way of example, the each of the power units 235a, 235b, 235c and 235d includes a motor for generating the rotational force, an encoder for detecting the rotational force of the motor, and a reduction gear for adjusting the rotational ratio of the motor.

The power units 235a, 235b, 235c and 235d disposed in the first, second, third and fourth joint parts 234a, 234b, 234c and 234d may be operated independently or may be operated at the same time by applying a desired voltage. Further, the first, second, third and fourth joint parts 234a, 234b, 234c and 234d may be operated using the power supplied from one of the power units 235a, 235b, 235c and 235d by linking the power of the first, second, third and fourth joint parts 234a, 234b, 234c and 234d to each other.

When the index finger part 230 disposed at the wrist part 210 is rotated horizontally, the power unit 235a of the first joint part 234a disposed at the lower side of the horizontal hinge part 212 of the wrist part 210 and the first link member 232a of the horizontal rotating part 236a is operated. Thus, the first joint 234a1 of the first joint part 234a is rotated by the power unit 235a and then the power is transmitted to the second joint 234a2.

Therefore, while the sliding motion is occurred between the contact surfaces of the pressure hemispherical parts formed at each end of the first and second joints 234a1 and 234a2, the contact surfaces are rotated around the rotational shaft provided between the contact surfaces. Sequentially, while the second joint 234a2 is rotated with the rotational shaft in the center, the first link member 232a coupled with the second joint 234a2 is reciprocated horizontally. Thus, the first link member 232a is rotated horizontally by the horizontal rotating part 236a coupled with the horizontal hinge part 212 of the wrist part 210.

Now, the vertical rotating motion of the second and third and fourth link members 232b, 232c and 232d will be described. Herein, the vertical rotating motion of the second and third and fourth link members 232b, 232c and 232d is performed through the equivalent processes, and thus the operation of the second link member 232b is described and the description of the third and fourth link members 232c and 232d are the equivalent processes that are shown in FIGS. 6-7 in order to avoid unnecessarily obscuring the embodiments of the invention.

First of all, in order to rotate the second link member 232b couple with the first link member 232a to be rotated vertically, the power unit 235b of the second joint part 234b provided between the first and second link members 232a and 232b is operated. Thus, the first join 234b1 forming the second joint part 234b is rotated by the power unit 235b and the power is transmitted to the second joint 234b2.

Therefore, while the sliding motion is occurred between the contact surfaces of the pressure hemispherical parts formed at each end of the first and second joints 234b1 and 234b2, the contact surfaces are rotated around the rotational shaft provided between the contact surfaces. Sequentially, while the second joint 234b2 is rotated with the rotational shaft in the center, the second link member 232b coupled with the second joint 234b2 is reciprocated vertically.

In a way of example, the third and fourth link members 232c and 232d are also reciprocated through the same processes. Smooth finger motion can be obtained by controlling the third and fourth link members 232c and 232d independently.

As described above, according to the joint apparatus of an embodiment of the invention, since each joint has a simple structure and can be operated independently, there is an advantage to provide the smooth finger motion.

Further, according to the hand apparatus using the joint apparatus of an embodiment of the invention, there is another advantage to provide a hand apparatus which can be smoothly operated like a human hand by using the joint apparatus which has a simple structure and can be operated independently.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A joint apparatus comprising:
a supporting part;
a rotating part configured to be rotated by a rotational force transmitted to the supporting part, wherein the rotating part is coupled to the supporting part; and
a joint part configured to convert the rotational force into a rotational motion using a sliding force that is generated at abutted surfaces formed at the end of the joint part in contact, wherein a first joint part resides within the rotating part and a second joint part resides within the supporting part.

2. A joint apparatus according to claim 1, wherein the joint part further comprising:
a first joint part resides in an axial direction of the rotating part having a hemispherical part formed at the end of the first joint part; and
a second joint part resides in an axial direction of the supporting part having a hemispherical part formed at the end of the second joint part,
wherein the sliding motion is occurred at the abutted surface of the hemispherical parts of the first and second joint part by contact.

3. A joint apparatus according to claim 2, wherein the sliding motion is initiated by a rotational force driven by the first joint part, and the rotational force is transmitted to the second joint part via the contact surface formed by coupling the supporting part and the rotating part, wherein the sliding motion is converted into the rotational motion.

4. A joint apparatus according to claim 1, wherein the rotational force is provided by a power unit coupled to the second joint.

5. A joint apparatus according to claim 4, wherein the power unit further comprising:
a motor configured to generate the rotational force,
a reduction gear configured to adjust a rotational ratio of the motor; and
an encoder configured to detect a rotational level of the motor.

6. A joint apparatus according to claim 1, wherein the supporting part includes an outer coupling part and the rotating part includes an inner coupling part that are hinged each other, wherein the first joint part and the second joint part are disposed within the hinged portion so as to restrict rotational motion within a limited space provided by the hinged portion.

7. A hand apparatus for a robot, comprising:
a wrist part;
a plurality of finger parts disposed in parallel to the wrist part having a plurality of link members;
a joint part disposed between the link members the joint part configured to convert a rotational force generated by a first joint part into a rotational motion of a second joint part, wherein the rotational force is converted into a hand motion occurred at contact surfaces of the each joint part abutted each other; and
a thumb part formed at the wrist part configured to be rotated.

8. A hand apparatus according to claim 7, further comprising:
the finger parts associated with a first link member the first link member configured to be rotated around horizontal axis with respect to the wrist part and a second link member configured to be rotated around vertical axis with respect to the first link member; and
the first joint part is disposed between the wrist part and the first link member, the first joint part configured to rotate the first link member around the horizontal axis with respect to the wrist part and the second joint part configured to rotate the second link member around vertical axis with respect to the first link member.

9. A hand apparatus according to claim 7, wherein the joint part further comprising:
the first joint part has an end having a first hemispherical contact that is coupled to the wrist part, wherein a power source is provided at the first joint part to supply the rotational force; and
the second joint part is disposed within the first link member and the second joint part has an end having a hemispherical contact, wherein the first and second contact are abutted.

10. A hand apparatus according to claim 7, wherein the sliding motion can be converted into a rotational motion by transmitting the rotational force to the second link member.

11. A hand apparatus according to claim 7, wherein the joint part further comprising:
a first joint is coupled to the first link member the first joint has a first pressure hemispherical contact surface formed at the end of the first joint, wherein a power unit is configured at the first joint to supply the rotational force; and
a second joint is disposed within the second link member and the second joint has a second pressure hemispherical contact surface formed at the end of the second joint, wherein the first and second contact parts are closely abutted.

12. A hand apparatus according to claim 7, wherein the sliding motion is initiated by a rotational force of the first joint part, and the rotational force is transmitted to the surface, wherein the surface is formed by abutting a first hemispherical contact surface and the second hemispherical contact surface, wherein the sliding motion is converted into the rotational motion transmitted to the second link member.

13. A hand apparatus according to claim 7, wherein the thumb part further comprising:
a supporting link configured to support for rotating associated with the wrist part; and
a rotating link configured to rotate by a motor, wherein one end of the rotating link is engaged at the wrist part, and the other end of the rotating part is engages at the thumb part.

14. A hand apparatus according to claim 7, wherein the thumb part further comprising:
a plurality of third link members configured to rotate the wrist part; and
a third joint part disposed between the third link members and the wrist part the third joint part configured to rotate the third link members.

15. An apparatus for providing a humanoid robot hand, comprising:
a plurality of joint members being coupled within a plurality of structures means for configuring a humanoid robotic hand, wherein the each joint member is a pair and each pair has a symmetrical shape at end;
means for disposing the pair within the structure and the each structure is hinged each other, wherein a space is formed at hinged part; and
means for providing a rotational force to a joint member, wherein the provided rotational force can be converted to a rotational motion through a sliding force occurred at the contact formed by the symmetrical shape of the each pair abutted against each other, wherein the rotational motion is converted into hand motion by the rotational motion is restricted within the space, wherein a desired motion for the humanoid robot hand can be achieved.

16. A method for providing a humanoid joint for a robotic system, the method comprising:
configuring a plurality of elements for embodying the humanoid robotic system, wherein the elements can include a supporting part, a motion part and a joint part;
forming a first contact at a hemispherical shape at the end of one joint part;
forming a second contact at a hemispherical shape at the end of the other joint, wherein the joint part is a pair;
disposing the joint part within the supporting part and the motion part respectively, wherein the supporting part and the motion part are hinged;
providing a power to a joint part having the first contact for generating a rotational force, wherein the rotational force is transmitted to the second contact abutted at the first contact at which a sliding force is occurred, wherein the sliding force causes the second contact to move, wherein the movements of the contact are restricted within the space formed at the hinged portion, wherein various motions can be achieved for the humanoid joint.
